(19) United States
(12) Patent Application Publication
(10) Pub. No.: US 2005/0287337 A1
(43) Pub. Date: Dec. 29, 2005

(54) Animal barrier for a tree and method of using same

(76) Inventor: Douglas Craig Proud, Minot Air Force Base, ND (US)

Correspondence Address: Cheryl F. Cohen, LLC, 2409 Church Road, Cherry Hill, NJ, 08002, US

(21) Appl. No.: 10/876,834

(22) Filed: Jun. 24, 2004

(51) Int. Cl. B32B 3/10

(52) U.S. Cl. 428/131

(57) ABSTRACT

An animal barrier for a Christmas tree having a plurality of levels of branches. The animal barrier including a shield having an inner aperture defined therethrough and an outer perimeter. The shield is made from a flexible material adapted to substantially conform in shape to the contour of one level of branches on the tree. A support frame is disposed proximate the outer perimeter of the shield. At least one releasable securing device is disposed from the inner aperture at least partially toward the outer perimeter. During installation the releasable securing device is disengaged and the shield is disposed between a first level and an adjacent second level of branches of the tree, higher than the first level of branches, with the inner aperture disposed proximate the trunk of the tree. The animal barrier rests on and is supported by the first level of branches. Then, the releasable securing device is engaged radially inward starting from the outer perimeter towards the inner aperture until the distance between the inner aperture and trunk is sufficiently small to substantially prevent passage therethrough by an animal. Alternatively, the animal barrier may be installed on an artificial Christmas tree by inserting the trunk of the tree through the inner aperture, thereby eliminating the need for a releasable securing device.

### BACKGROUND OF THE INVENTION

1. Field of the Invention

The present invention is directed to a safety device for animals and, in particular, to a barrier device for preventing animals from climbing up the trunk or branches proximate the trunk of a Christmas tree.

2. Description of Related Art

Animals, and in particular, cats are inclined to climb up the trunk of a Christmas tree during the holiday season. This is troublesome in that the health and safety of the animal is of great concern if the animal eats a harmful object on the tree such as tinsel, ornaments or lights. Another concern is that the animal may knock over and damage or destroy a valuable or priceless Christmas decoration hanging on the tree. Aside from the safety of the animal and the prevention of damage to personal property, yet another problem associated specifically with artificial trees is that often the animal's movement while climbing up the tree may dislodge an artificial branch. It is time consuming and frustrating to insert the branch properly into its slot on the trunk without first dismantling and/or removing the objects hung on the tree.

Heretofore, veterinarians typically recommend as the best option to locate the Christmas tree in a remote and isolated room to which the animal is prohibited from accessing. Most often this option is impractical and undesirable. As an alternative, it is often recommended to place objects such as ornaments, tinsel or lighting high up on the tree away from the lower branches that are readily accessible by the animal from the floor. Decorating only the upper branches of the Christmas tree distracts from its overall pleasing and symmetric appearance. This obviously is not a comprehensive solution since it does not deter the animal from climbing up the trunk of the tree thereby accessing the higher or elevated branches. The overall weight of the animal when climbing up the trunk of the tree may cause the tree itself to topple over the consequences of which may damage personal property and/or be potentially harmful to the animal itself. Pet owners typically anchor the tree to a wall or ceiling to provide additional support. Even if the tree is anchored to the wall to prevent it from tipping over, once again this does not deter the animal from climbing up the trunk and accessing the objects hung from the tree.

Some solutions have heretofore been offered to prohibit a pet from climbing up the trunk of a Christmas tree. One option is to spray the trunk and lower branches with an indoor spray repellant, e.g., a cat spray repellant. By way of example, a citrus (e.g., lemon) scented air freshener, which cats are usually repelled by, can be hung from the lower branches of the tree or sprayed directly onto the branches and trunk of the tree. Other spray repellents having a less than pleasant odor are also manufactured. Spray repellant solutions are not always successful in prohibiting the animal from climbing up the tree in that the scent will dissipate over time and thus have to be reapplied. Another disadvantage is that often times the tree is located in a place of your house in which it is difficult to maneuver to spray the tree, especially the lower branches and base. Furthermore, depending on its chemical composition the spray repellant may diminish the effective fire retardant properties of the chemicals with which most artificial trees have been treated and/or damage the fake snow sprayed onto the tree branches. The use of air freshener dispensers containing chemical repellants, on the other hand, disadvantageously distract from the overall aesthetic appearance of the tree.

Mats are manufactured that generate a mild electrical shock when an object such as an animal walks on their surface. To deter animals from climbing up the trunk of the Christmas tree, several mats may be positioned on the floor around the base of the tree. Animal owners generally are reluctant to subject their pets to such treatment and incur this additional expense.

Another option is to position a carpet runner on the floor around the base of the tree with the spikes turned upwards. The premise being that the animal will be discouraged from walking on the exposed spikes. Because the carpet runners are turned upside down with the spikes facing upwards the animal can readily slide the carpet out of its way along the floor making itself a clear pathway. In addition, the spikes may pose a health concern for the animals should they not be deterred and walk on the exposed spikes.

It is therefore desirable to develop an improved Christmas tree animal barrier that is relatively inexpensive to manufacture, easy to install, inconspicuous, safe to any animal, free from odor and stores readily with minimal space.

### SUMMARY OF THE INVENTION

The present invention is directed to an animal barrier that solves the aforementioned problems associated with conventional methods and devices for preventing or deterring animals from climbing up a Christmas tree.

The animal barrier in accordance with the present invention is concealed between lower layers or levels of branches of the Christmas tree thereby not distracting from the aesthetic appearance of the tree and objects hung thereon.

In a first embodiment, the present invention relates to an animal barrier for a tree, e.g., a Christmas tree, having a plurality of levels of branches. The animal barrier includes a shield having an inner aperture defined therethrough and an outer perimeter. The shield is made from a flexible material adapted to substantially conform in shape to the contour of one level of branches on the tree. A support frame is disposed proximate the outer perimeter of the shield. At least one releasable securing device is disposed from the inner aperture extending at least partially toward the outer perimeter of the shield. During installation the releasable securing device is disengaged and the shield is disposed between a first level and an adjacent second level of branches of the tree, higher than the first level of branches, with the inner aperture of the shield disposed proximate the trunk of the tree. The animal barrier rests on and is supported by the first level of branches. Then, the releasable securing device is engaged radially inward starting from the outer perimeter towards the inner aperture until the distance between the inner aperture and trunk is sufficiently small to substantially prevent passage therethrough by an animal. Alternatively, the animal barrier may be installed on an artificial Christmas tree by inserting the trunk of the tree through the inner aperture, thereby eliminating the need for a releasable securing device or maintaining the releasable securing device in an engaged state during installation.

Also, the present invention relates to a method for installing an animal barrier between two levels of branches of a tree. The animal barrier includes a shield having an inner aperture and an outer perimeter. At least one main releasable securing device extends from the inner aperture through to the outer perimeter of the shield. Initially, one or more main releasable securing device are disengaged. The animal barrier is then positioned between a first level of branches and an adjacent second level of branches, higher than the first level of branches, with the inner aperture disposed proximate the trunk of the tree. Finally, the animal barrier is laid to rest on the first level of branches. Thereafter, one or more main releasable securing devices are at least partially engaged starting from the outer perimeter and moving radially inward toward the inner aperture sufficient to substantially prevent passage of an animal between the inner aperture and trunk of the tree.

The present invention is further directed to a method for installing an animal barrier in an artificial tree having a trunk and a plurality of branches mountable to the trunk. The animal barrier includes a shield having an inner aperture defined therein. Initially, the animal barrier is installed between a first level of branches and an adjacent second level of branches, higher than the first level of branches. This is achieved by inserting the trunk of the tree through the inner aperture of the animal barrier. Thereafter, the animal barrier is supported by the first level of branches.

### BRIEF DESCRIPTION OF THE DRAWING

The foregoing and other features of the present invention will be more readily apparent from the following detailed description and drawings of illustrative embodiments of the invention wherein like reference numbers refer to similar elements throughout the several views and in which:

FIG. 1a is an exemplary top view of a first embodiment of an animal barrier while in a closed state in accordance with the present invention wherein the support frame is configured as an open loop;

FIG. 1b is a perspective view of the animal barrier of FIG. 1a with the releasable securing device in an open state and a portion of the shield removed to reveal the support frame;

FIG. 1c shows a cross-sectional view of the animal barrier in FIG. 1a along the line C-C;

FIGS. 1d & 1e show each step in the installation of the animal barrier of FIG. 1a on a Christmas tree;

FIG. 1f shows a side view of the animal barrier of FIG. 1a installed in the Christmas tree;

FIG. 1g shows the animal barrier of FIG. 1a folded into approximately one quarter of its original size for storage;

FIG. 2a is an exemplary top view of a second embodiment of an animal barrier in accordance with the present invention wherein the support frame forms a closed loop;

FIG. 2b is a perspective view of the animal barrier of FIG. 2a with the releasable securing device in an open state and a portion of the shield removed to reveal the support frame;

FIGS. 2c-2e show each step in the installation of the animal barrier of FIG. 2a on a Christmas tree;

FIGS. 3a-3c diagrammatically depicts the steps in reducing in size the animal barrier, wherein the shield has been removed to clearly reveal the support frame; and

FIG. 3d shows the animal barrier including the shield in a collapsed state for storage.

### DETAILED DESCRIPTION OF THE PREFERRED EMBODIMENTS OF THE INVENTION

By way of illustrative example only, the present inventive animal barrier is shown and described as being installed on a Christmas tree, however, the device may be used with any type of tree having a plurality of layers or levels of branches, typically a tree having branches relatively low to the ground, to which an animal may have access, irrespective of whether the tree is located indoors or outdoors.

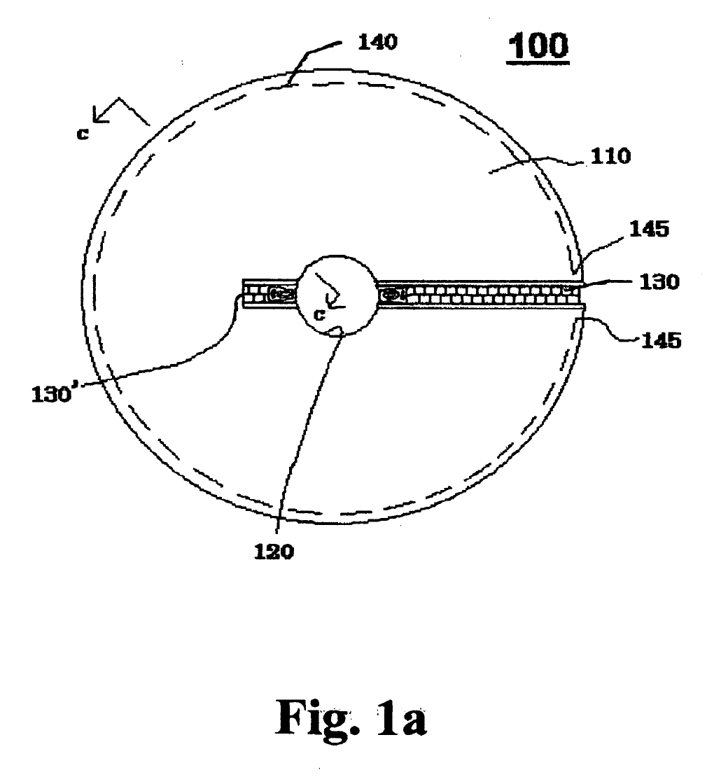

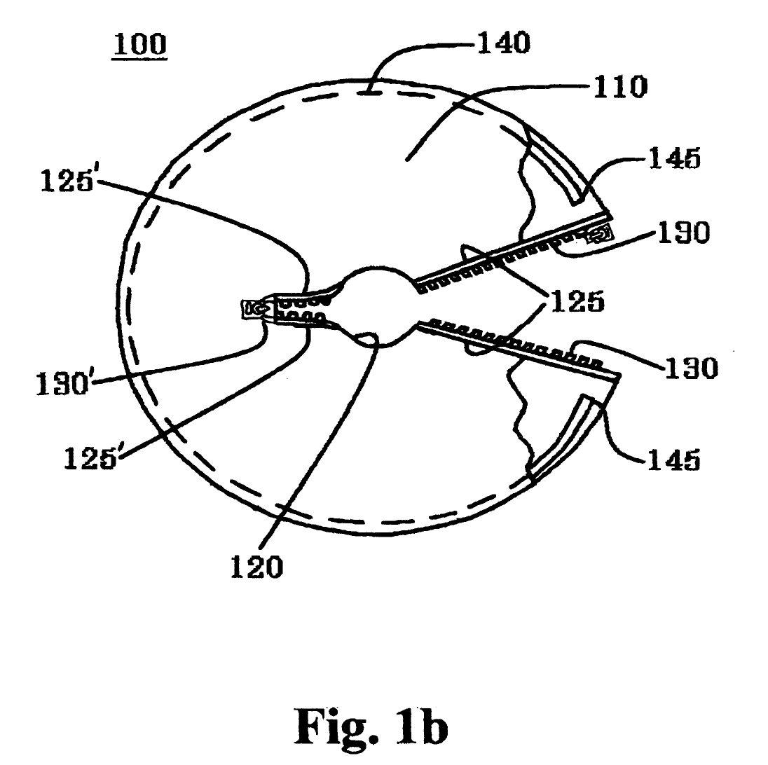

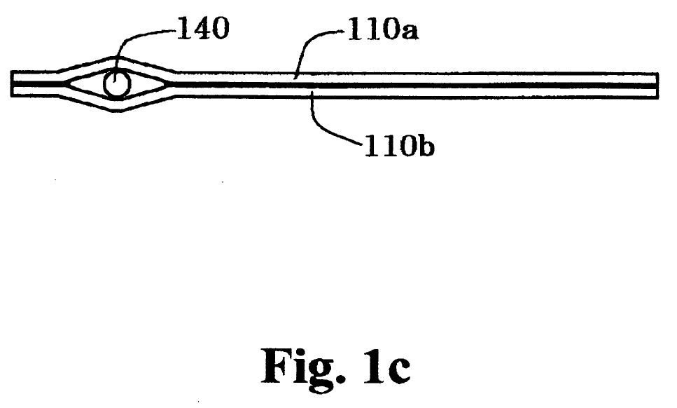

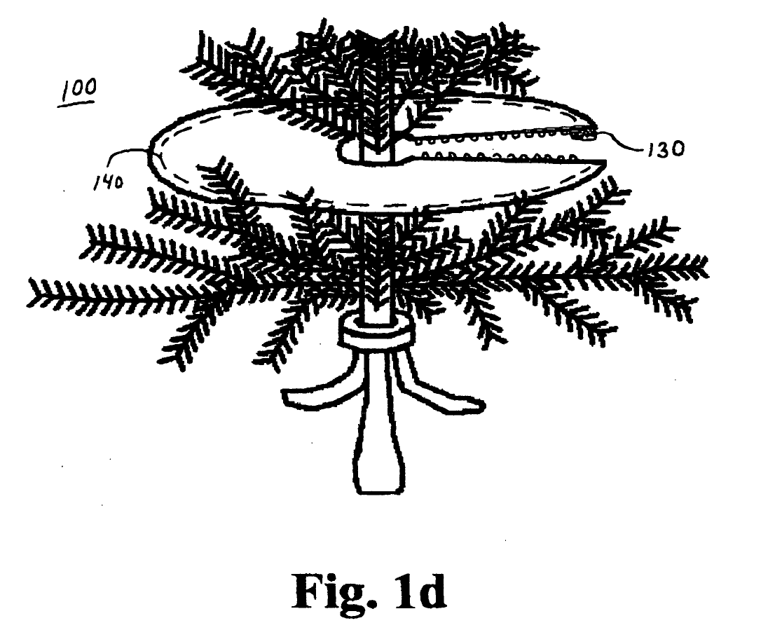

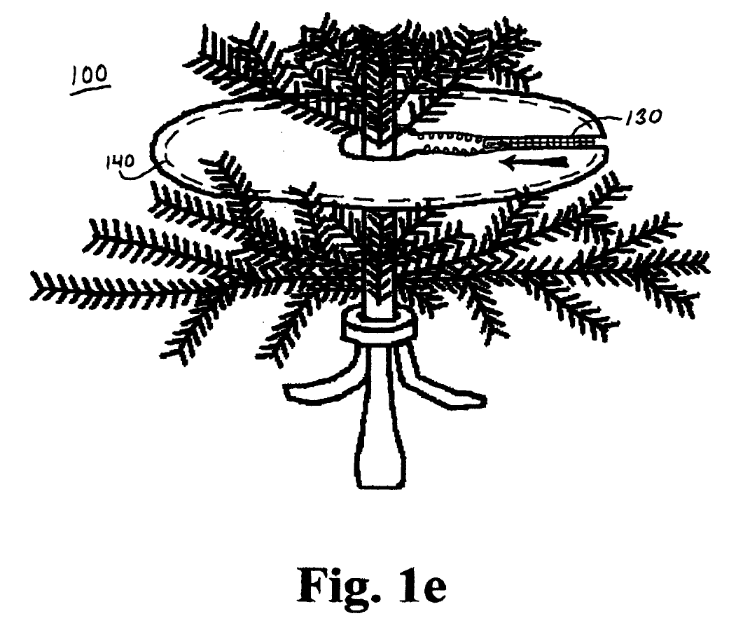

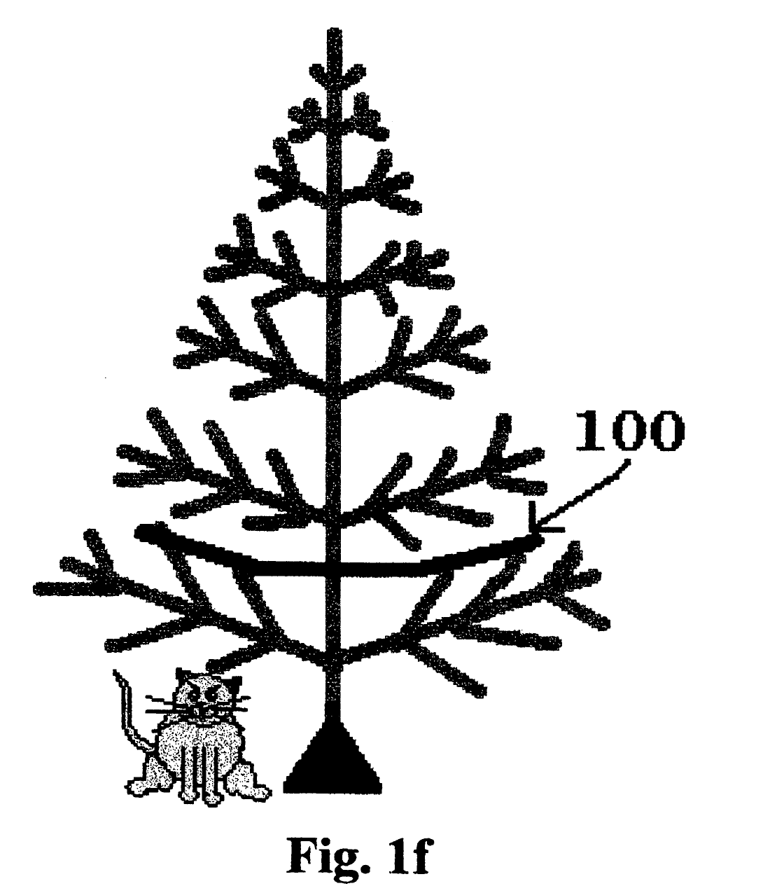

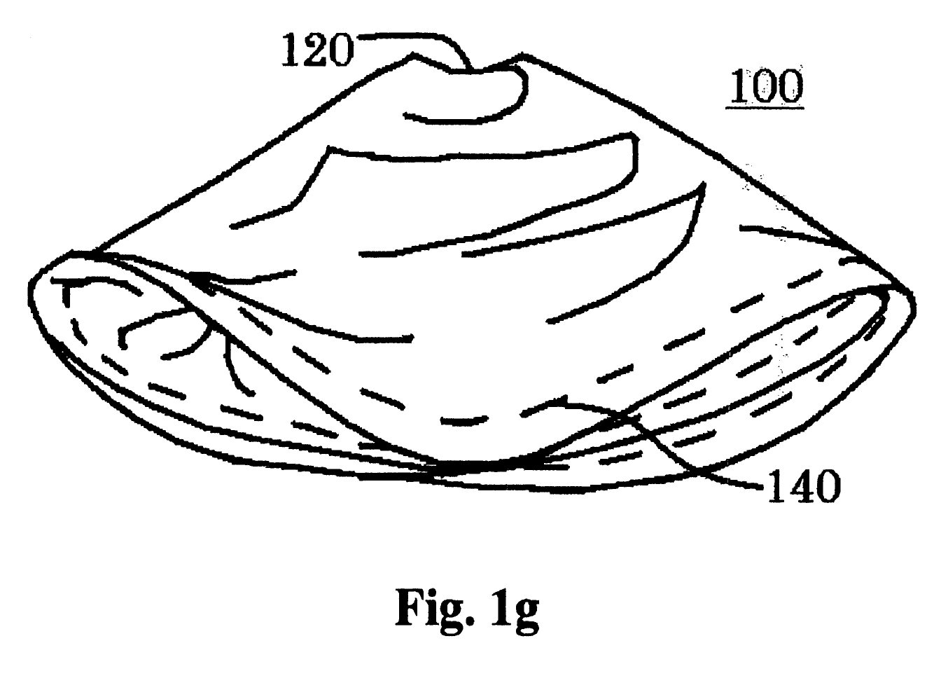

FIG. 1a shows a top view of an exemplary first embodiment of an animal barrier 100 in accordance with the present invention. The animal barrier 100 includes a shield or panel 110 preferably made from a material such as fabric, e.g., nylon, canvas, cotton, polyester, or fleece, sufficiently flexible so as to conform to the contour defined by any given layer of branches upon which the animal barrier 100 rests when installed on a Christmas tree. Generally, the branches on any given level of a Christmas tree, whether real or artificial, slope upwards starting from the trunk and extending radially outward. Since the shield is adapted to conform in shape to the contour of the branches of the tree on any given level, the animal barrier when installed on the tree will generally take on a similar upward cone configuration (FIG. 1f). To encourage this cone configuration when assembled on the tree the shield may be designed with a wedge or section thereof removed, as shown in the open state view of FIG. 1b. Such configuration of the animal barrier is not essential to the invention but merely preferred to further emphasize this cone shape configuration when assembled on the tree.

In addition, the flexibility of the material from which the shield or panel 110 is manufactured preferably allows the animal barrier 100 to be readily folded or collapsed for storage purposes. The color of the material used to manufacture the shield may be selected, as desired, but preferably is transparent or a color that will substantially match that of the branches of the tree to conceal its appearance when installed. In the embodiment shown in FIG. 1a, the outer perimeter of the shield 110 is substantially circular in shape. This is preferable in that a substantially circular shape conforms to the generally circular outline defined by the outer tips of the branches of any given level or layer of the Christmas tree. It is, however, contemplated and within the intended scope of the present invention for the shield 110 to be designed to any desired shape, e.g., elliptical. The shield 110 is preferably sized so that when installed on the tree the outer perimeter of the shield 110 will extend proximate but radially inward from the tips of the branches of any given lower level or layer, not necessarily the bottom layer or level, on which the shield will rest. It is preferable for the animal barrier 100 to be slightly smaller in size, for example, in the range between approximately 6 inches and approximately 10 inches smaller, than that of the branches on which it is to rest so as to be concealed from sight.

Shield 110 has an inner aperture 120 defined therein. Animal barrier 100, shown by way of example in FIG. 1a, has a substantially centered circular shaped inner aperture 120. This substantially circular shape inner aperture is preferable so as to substantially conform with the generally circular shape of the outer perimeter of the trunk of the Christmas tree. Nevertheless, the animal barrier 100 may be designed, as desired, to have any shape inner aperture. The size of the inner aperture is preferably selected on the one hand to be sufficiently large so as to be disposed about the trunk of the Christmas tree without obtaining any support from the trunk of the tree, yet on the other hand small enough to prevent the animal from climbing up the trunk of the Christmas tree through the inner aperture 120 of the animal barrier 100 when installed.

In the embodiment shown in FIGS. 1a & 1b, the shield or panel 110 has at least one primary or main cut defined therein extending radially therethrough between the inner aperture and the outer perimeter thereby forming a pair of mating or terminating edges 125 along the cut. A releasable securing device 130 is disposed along at least a portion of the mating or terminating edges 125 of the shield or panel 110 to secure the edges 125 together. Even in this secured, engaged or closed state the animal barrier is sufficiently flexible so as not to retain a three dimensional shape, but instead adapts to the contour of the surface on which it is supported. FIG. 1a shows a zipper, however, any other type of releasable closing device 130 is contemplated such as Velcro™, hook and eyes, a rope laced through associated eyelets disposed on both terminating edges, buttons and associated holes, snaps or buckles. A supplemental or auxiliary cut may be defined preferably diametrically opposite the first cut, but unlike the first cut extends radially only partially through the shield from the inner aperture 120 radially outward towards the outer perimeter. A pair of associated mating or terminating edges 125′ is formed along the supplemental or auxiliary cut. Like the first cut, the supplemental or auxiliary cut forms a pair of associated mating or terminating edges 125′ along the cut and has an associated releasable securing device 130′, not necessarily the same as the first releasable securing device 130. The supplemental or auxiliary cut and its associated releasable securing device allows the user to increase the diameter of the inner aperture 120 to accommodate a tree trunk of large girth (e.g., for natural Christmas trees) and simultaneously substantially center the animal barrier 100 about the trunk of the Christmas tree. It is noted that the supplemental or auxiliary cut is not necessary and may be eliminated, if desired. Despite only one primary or main cut being shown and described with respect to FIGS. 1a & 1b, any number of one or more primary cuts extending radially therethrough from the inner aperture 120 to the outer perimeter may be employed, as desired, thereby dividing the shield 110 into multiple sections connected or attached by an associated releasable securing device. Multiple sections aid in installing the animal barrier on the Christmas tree but at the expense of increasing the overall cost of manufacture. In addition, the animal barrier may also be designed, as desired, to include more than one supplemental or auxiliary cut and its associated releasable securing device to accommodate a trunk of extremely large girth.

A support frame or skeleton 140 is disposed proximate the outer perimeter of the shield 110. The support frame 140 is made from a semi-rigid yet flexible material, preferably a resilient flexible material, e.g., a narrow strap, wire or chain having two terminating or free ends 145, that automatically “springs back” to its original shape so as to rest against the branches of the Christmas tree after being pushed upwards by an animal attempting to climb up the tree trunk. Support frame 140 is preferably secured, e.g., glued or sewn, in position relative to the shield 110 to prevent shifting. As shown in FIG. 1b, the terminating or free ends 145 of the support frame 140 in accordance with the first embodiment are disposed separated from one another by a predetermined distance to form an open loop.

Shield 110, as illustrated in the cross-sectional view shown in FIG. 1c, may be made from two pieces of material adhered, e.g., sewn or glued, together about the outer perimeter and inner perimeter. Alternatively, a single piece of material may be used whereby a portion of the shield proximate its outer perimeter is wrapped about the support frame 140 and secured to form a hem or channel.

FIGS. 1d-1e show the steps performed in installing the animal barrier 100 on a Christmas tree. The releasable securing device is released, disengaged or opened, as shown in FIG. 1b, so that the mating or terminating edges 125 are no longer secured together. While in a released, disengaged or open state with the mating or terminating edges 125 separated from one another, the shield or panel 110 may be readily positioned between a first level and an adjacent second level of branches of the tree, higher than the first level of branches, with the inner aperture 120 disposed proximate the trunk of the Christmas tree, as shown in FIG. 1d. The first level of branches may, but need not necessarily be, the bottom level or layer of branches of the Christmas tree. The releasable securing device 130 is then secured, engaged or closed, preferably starting from the outer perimeter of the animal barrier 100 and moving radially inward (as denoted in the FIG. 1e by the arrow), until the distance between the trunk of the tree and inner aperture 120 is sufficiently small so as to prevent or prohibit the animal from climbing up the tree between the trunk and inner aperture. While in a closed state, since no support is required or provided by the trunk of the tree, the perimeter of the inner aperture 120 need not rest nor contact the trunk. Instead, support is provided exclusively by the branches on any given layer or level on top of which the animal barrier rests and conforms in contour. To uninstall the animal barrier from the Christmas tree, the reverse process is performed.

In the case of an animal barrier having multiple primary cuts, the same process is performed except that the releasable securing device associated with any one or more of the primary cuts may be released, disengaged or opened prior to arranging the animal barrier about the trunk of the tree. Thereafter, the releasable securing devices are engaged preferably starting from the outer perimeter and advancing radially inward toward the inner aperture. In the case in which the animal barrier is to be used with a tree having a trunk whose girth exceeds that of the inner aperture, the releasable securing device associated with the supplemental or auxiliary cut may be disengaged prior to or simultaneously while positioning the shield about the trunk of the tree. Once substantially centered in position, the releasable securing devices associated with the supplemental and/or the primary cut are engaged by advancing radially inward from the outer perimeter towards the inner aperture until the distance between the trunk and shield is sufficiently small to prohibit an animal from passing therebetween.

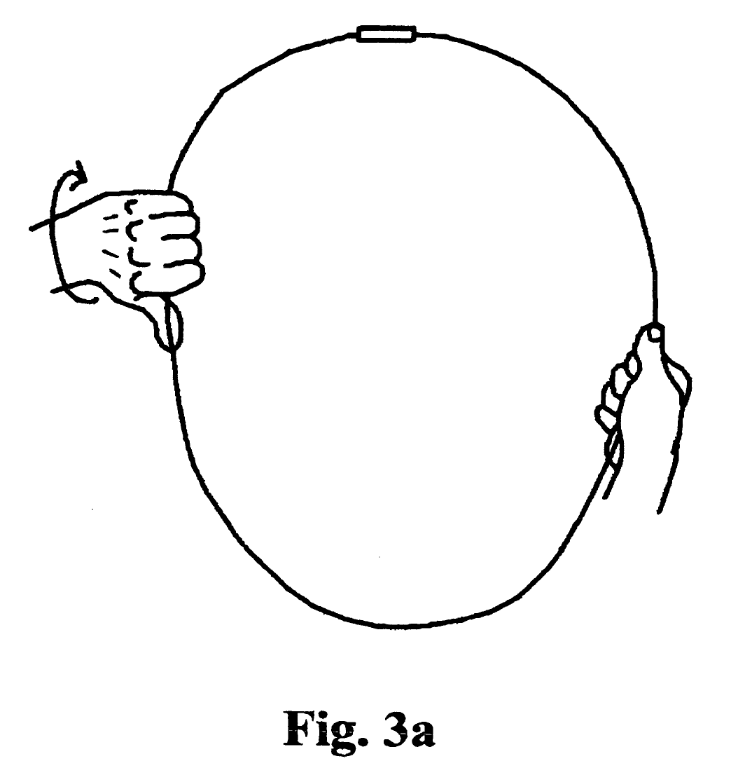

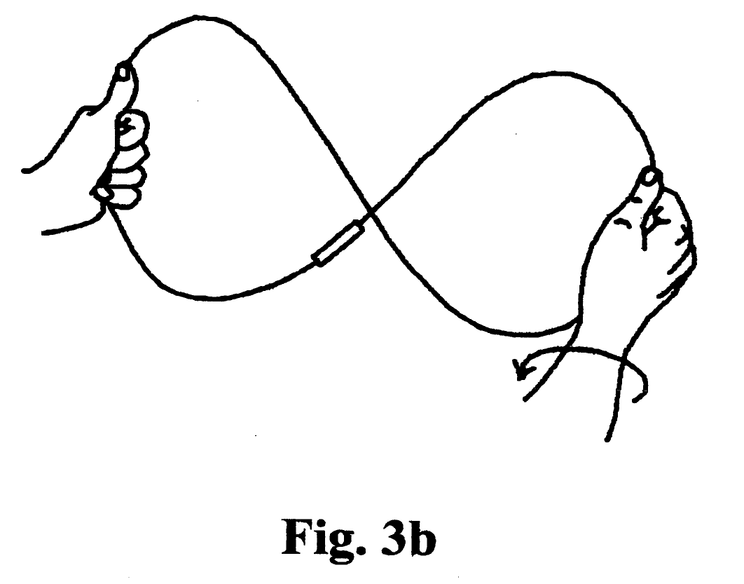

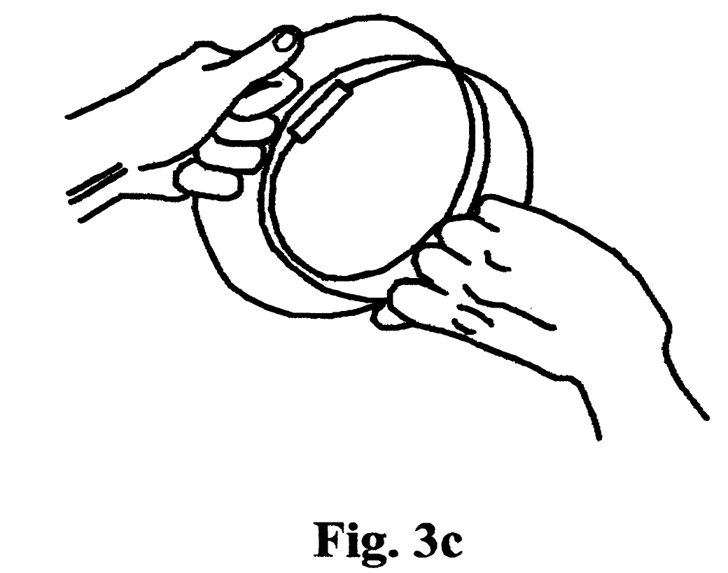

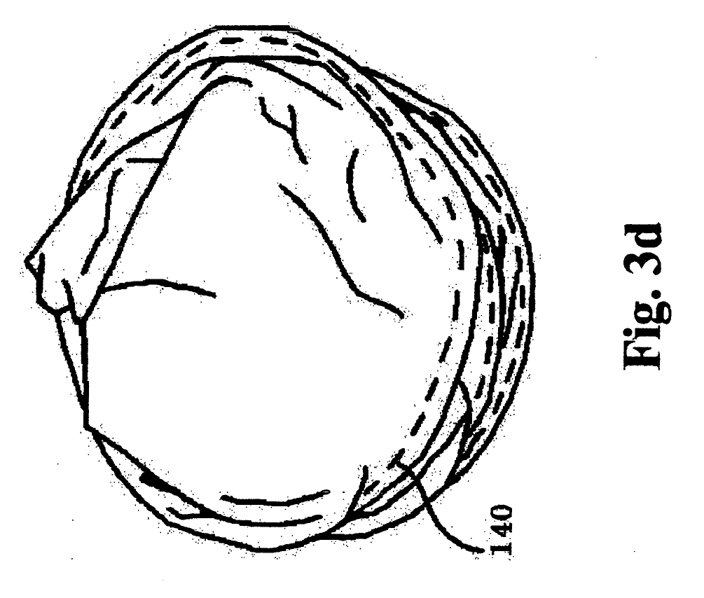

The animal barrier in accordance with the present invention may preferably be folded or collapsed for easy storage. In the open loop configuration in accordance with the first embodiment the support frame preferably is sufficiently flexible to permit the animal barrier to be folded or collapsed onto itself thereby reducing its overall size for easy storage. By way of example, FIG. 1g shows the animal barrier of FIG. 1a folded loosely in half and then in half again into one quarter its original size. Alternatively, the animal barrier may be collapsed by twisting and simultaneously rotating the shield to reduce its overall size, for example, by one third, as explained in detail below and shown in FIGS. 3a-3d. Nevertheless, the animal barrier may be folded or collapsed in a different configuration. The more compact or smaller in overall size the more desirable from a storage perspective. The extent to which the animal barrier may be folded or collapsed, if at all, is dependent on such factors as the flexibility of the material used to form both the shield 110 and support frame 140. Regardless of whether the animal barrier is folded or collapsed the support frame is preferably not creased or bent.

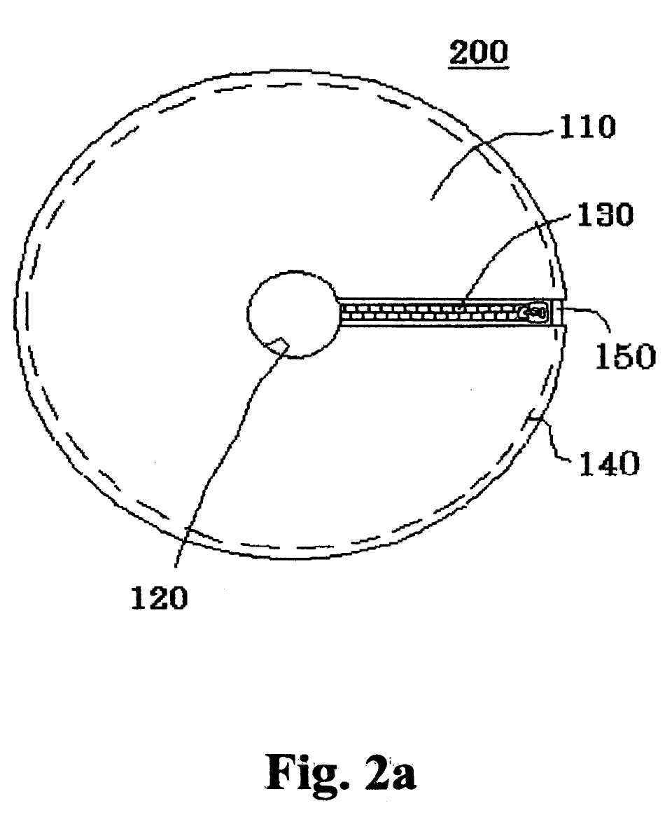

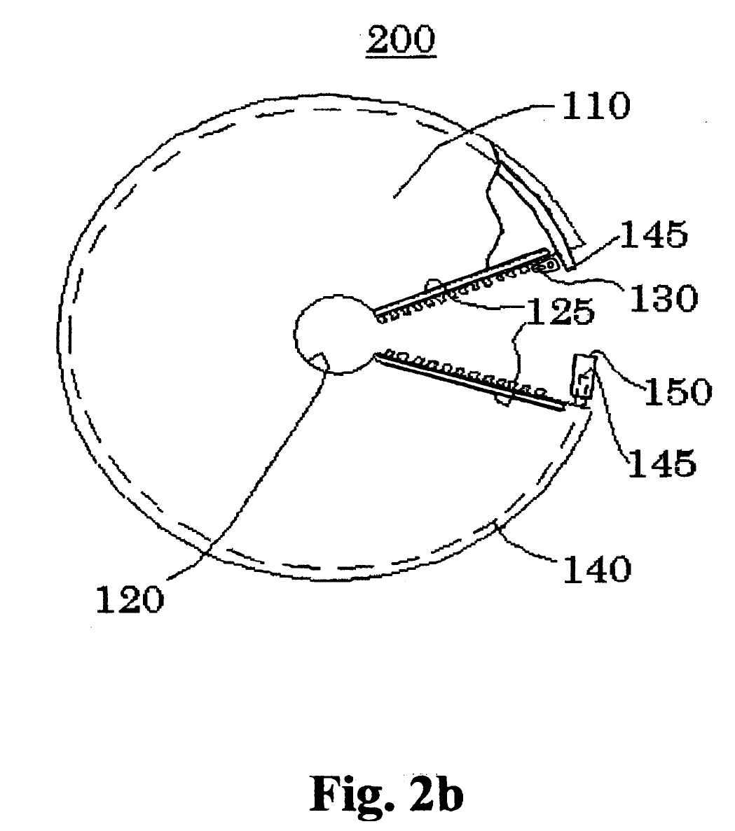

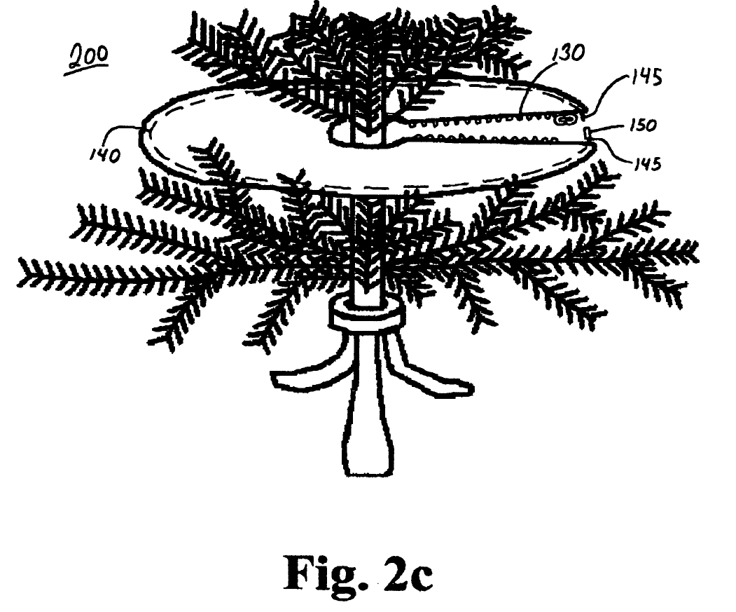

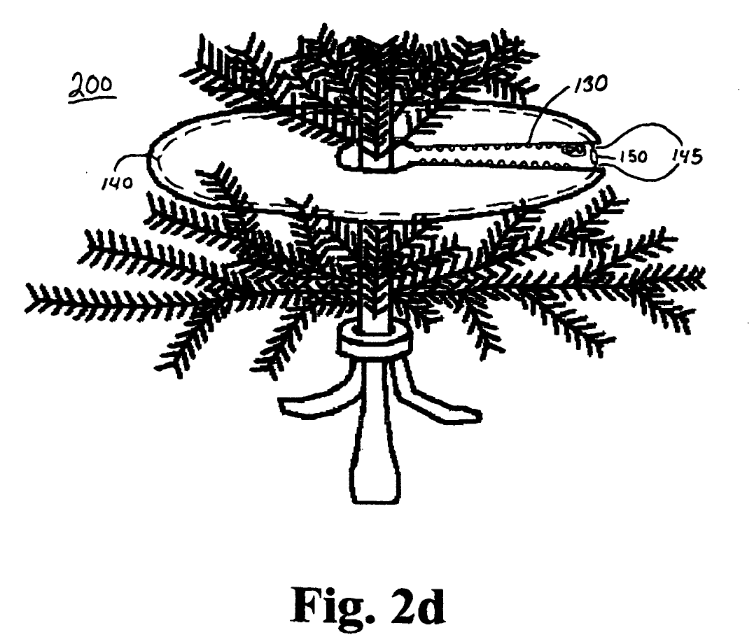

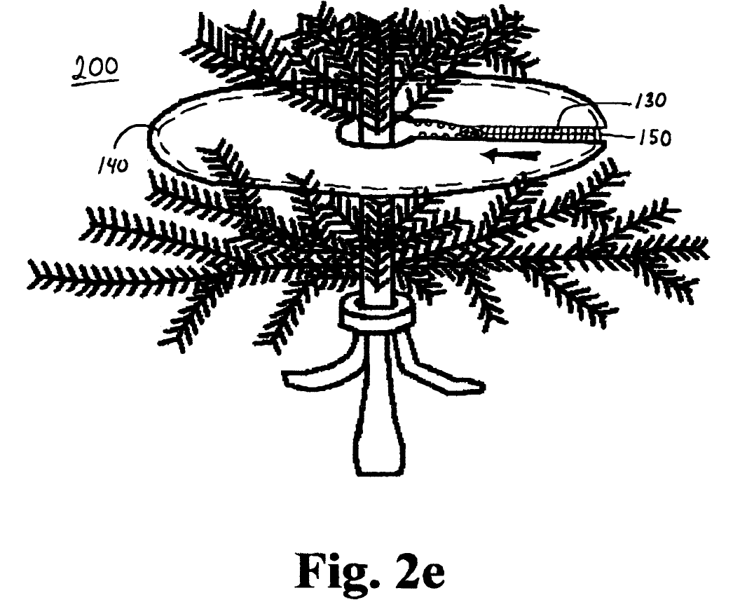

An alternative second embodiment is shown in FIGS. 2a-2e. The second embodiment differs from that of the first embodiment in that the two terminating or free ends 145 of the support frame 140 are secured together via a coupler, adapter or connector 150 to form a closed loop, as shown in FIG. 2b. No supplemental or auxiliary cut is shown in the second embodiment, however, one could be employed, if desired.

FIGS. 2c-2e depict the steps performed in installing the animal barrier 200 in accordance with the present invention on a Christmas tree. During installation, one of the free ends 145 of the support frame 140 is disengaged from the coupler 150 and the releasable securing device 130 is disengaged, as shown in FIG. 2b. Thereafter, the animal barrier 200 is wrapped around the tree between two layers or levels of lower branches with the inner aperture 120 disposed about the trunk of the Christmas tree. Once the inner aperture is positioned about the trunk of the tree, the animal barrier is laid to rest on top of the level or layer of branches over which it is disposed. The terminating or free ends 145 of the support frame 140 are inserted into the respective ends of the coupler 150 to form a closed loop. Preferably, one end of the terminating or free ends 145 of the support 140 is permanently secured in the coupler 150 so that the coupler does not get lost. Finally, the releasable securing device 130 is engaged or secured, preferably starting from the outer perimeter of the animal barrier 200 working radially inward toward the inner aperture 120. Alternatively, the releasable securing device 130 may be engaged prior to connecting the terminating or free ends 145 of the support frame 140 to form a closed loop.

The closed loop configuration of the animal shield in accordance with the second embodiment is preferably adapted so that the support frame may be conveniently collapsed by simultaneously twisting and rotating the animal barrier thereby reducing its size, as shown in FIGS. 3a-3d, wherein the shield 110 has been removed revealing only the support frame 140 so as to clearly illustrate the motions undertaken to collapse the structure. While in a collapsed state (FIG. 3d) the support structure 140 will exert counterbalancing forces to automatically return to its original shape and thus is preferably stored in a bag or pouch to maintain its reduced size. Alternatively, releasable retaining devices such as straps could be used to prohibit the animal barrier, while in a disassembled and collapsed state, from returning to its original shape. The releasable retaining device may be separate from the animal barrier or secured to the animal barrier either permanently or detachably. If secured to the animal barrier then the releasable retaining device may either be: (i) secured so as not to attract the animal's attention; or (ii) adapted so that when the animal shield is installed on the tree the releasable retaining device is out of view from the animal's sight.

In the first and second embodiments described above the animal barrier employs a releasable securing device so as to release, disengage or open the shield thereby aiding in placement of the animal barrier about the trunk of the tree. It is, however, contemplated that the releasable securing device may be omitted altogether. This configuration would be particularly well suited for an artificial tree including a trunk and a plurality of detachable branches mountable to the trunk. During assembly of the artificial tree, the trunk is received through the inner aperture of the animal barrier. Insertion of the trunk through the inner aperture of the animal barrier may occur prior to assembly of any branches whereby the animal barrier would have to be manually held or supported in position above that of the lower level branches to be assembled to the trunk. Alternatively, the trunk may be inserted through the inner aperture of the animal barrier after one or more lower level branches have already been assembled to the trunk at a desired height at which the animal barrier is to rest. After receiving the trunk through the inner aperture of the animal barrier the remaining upper level branches are readily mounted on the tree.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

Every issued patent, pending patent application, publication, journal article, book or any other reference cited herein is each incorporated by reference in their entirety.

1. An animal barrier for a tree having a plurality of levels of branches, comprising:
a shield having an inner aperture defined therethrough and an outer perimeter, the shield being made from a flexible material adapted to substantially conform in shape to the contour of one level of branches on the tree.

2. The animal barrier in accordance with claim 1, wherein the inner aperture is substantially centered.

3. The animal barrier in accordance with claim 1, wherein the inner aperture is substantially circular.

4. The animal barrier in accordance with claim 1, wherein the shield has at least one cut defined therethrough extending from the inner aperture at least partially towards the outer perimeter so as to form two terminating edges.

5. The animal barrier in accordance with claim 4, further comprising a releasable securing device disposed along at least a portion of the two terminating edges.

6. The animal barrier in accordance with claim 4, wherein the at least one cut includes at least one main cut extending completely from the inner aperture through to the outer perimeter.

7. The animal barrier in accordance with claim 4, wherein the at least one cut includes a plurality of main cuts each extending completely from the inner aperture through to the outer perimeter.

8. The animal barrier in accordance with claim 4, wherein the at least one cut includes at least one main cut extending from the inner aperture through to the outer perimeter, and at least one supplemental cut extending from the inner aperture partially towards the outer perimeter.

9. The animal barrier in accordance with claim 1, further comprising a support frame disposed proximate the outer perimeter of the shield.

10. The animal barrier in accordance with claim 9, wherein the support frame is made from a semi-rigid flexible material adapted to spring back to its substantially original shape when a force exerted thereupon is removed.

11. The animal barrier in accordance with claim 9, wherein the support frame has two terminating ends.

12. The animal barrier in accordance with claim 11, further comprising a coupler adapted to connect the terminating ends of the support frame to form a closed loop.

13. The animal barrier in accordance with claim 1, wherein the inner aperture is sized so as to be disposed about, but not supported by, the trunk of the tree.

14. The animal barrier in accordance with claim 1, wherein the outer perimeter of the shield is adapted to be smaller in size than the branches on the level of the tree on which it is to be supported.

15. A method for installing an animal barrier between two adjacent levels of branches of a tree, the animal barrier including a shield having an inner aperture and an outer perimeter, at least one main releasable securing device extending from the inner aperture through to the outer perimeter, comprising the steps of:
disengaging the at least one main releasable securing device; and
positioning the animal barrier between a first level of branches and an adjacent second level of branches, higher than the first level of branches, with the inner aperture disposed proximate the trunk of the tree; and
resting the animal barrier on the first level of branches.

16. The method in accordance with claim 15, further comprising the step of at least partially engaging the at least one main releasable securing device starting from the outer perimeter and moving radially inward toward the inner aperture sufficient to substantially prevent passage of an animal between the inner aperture and trunk of the tree.

17. The method in accordance with claim 15, wherein the animal barrier includes a support frame having two terminating ends, the support frame being disposed proximate the outer perimeter of the shield.

18. The method in accordance with claim 17, further comprising the step of securing the terminating ends of the support frame together to form a closed loop.

19. The method in accordance with claim 17, wherein the terminating ends of the support frame remain separated a predetermined distance when the main releasable securing device is in an engaged state.

20. The method in accordance with claim 17, wherein the support frame is made from a semi-rigid flexible material adapted to spring back to its substantially original shape when a force exerted thereupon is removed.

21. The method in accordance with claim 15, wherein the animal barrier includes a plurality of main releasable securing devices each extending from the inner aperture through to the outer perimeter.

22. The method in accordance with claim 15, wherein the animal barrier includes at least one supplemental releasable securing device extending partially from the inner aperture outward toward the outer perimeter.

23. The method in accordance with claim 15, wherein the animal barrier includes a plurality of supplemental releasable securing devices each extending partially from the inner aperture outward toward the outer perimeter.

24. The method in accordance with claim 15, wherein the shield is made from a flexible material adapted to substantially conform in shape to the contour of the first level of branches on the tree on which it is supported.

25. The method in accordance with claim 15, wherein the first level of branches is a bottom level of branches on the tree.

26. The method in accordance with claim 15, wherein the first level of branches is not a bottom level of branches on the tree.

27. A method for installing an animal barrier in an artificial tree having a trunk and a plurality of branches mountable to the trunk, the animal barrier including a shield having an inner aperture defined therein, comprising the steps of:
installing the animal barrier between a first level of branches and an adjacent second level of branches, higher than the first level of branches; and
resting the animal barrier on the first level of branches.

28. The method in accordance with claim 27, wherein the installing step comprises the steps of:
mounting to the trunk of the tree the levels of branches including and below the first level of branches; and
inserting the trunk of the tree through the inner aperture of the animal barrier.

29. The method in accordance with claim 28, further comprising the step of mounting to the trunk of the tree the levels of branches including and above the second level of branches.

30. The method in accordance with claim 27, wherein the installing step further comprises the steps of:
supporting the animal barrier while mounting to the trunk of the tree the levels of branches including and below the first level of branches.

31. The method in accordance with claim 30, further comprising the step of mounting to the trunk of the tree the levels of branches including and above the second level of branches.

32. The method in accordance with claim 27, wherein the first level of branches is a bottom level of branches.

33. The method in accordance with claim 27, wherein the first level of branches is not a bottom level of branches.
